(19) United States
(12) Patent Application Publication
(10) Pub. No.: US 2006/0050636 A1
(43) Pub. Date: Mar. 9, 2006

(54) Traffic restriction in packet-oriented networks by means of link-dependent limiting values for traffic passing the network boundaries

(76) Inventor: Michael Menth, Oellingen (DE)

Correspondence Address: Siemens Corporation;Intellectual Property Department, 170 Wood Avenue South, Iselin, NJ, 08830, US

(21) Appl. No.: 10/542,725

(22) PCT Filed: Jan. 14, 2004
(86) PCT No.: PCT/EP04/00218

§ 371 Date: Jul. 20, 2005

(30) Foreign Application Priority Data
Jan. 20, 2003 (DE) 10301967.7

(51) Int. Cl. H04L 12/26; H04J 1/16; H04J 3/14

(52) U.S. Cl. 370/230; 370/235; 370/248

(57) ABSTRACT

The invention relates to a method for controlling the access to a packet-oriented network. An authorization check is carried out for a group of packets by means of a limited value affecting a partial section of the network, the limiting value representing a boundary for all traffic which circulates over the partial section and passes over the input nodes or the output nodes of the network. The transmission of the group of data packets is not authorized if an authorization of transmission would lead to traffic exceeding the limiting value. The access control can be carried out for all partial sections over which the packets of the flow are to be transmitted. Overload and blockage situations in the partial section concerned can be avoided by the access control. The inventive access control can be combined with other access controls in order to achieve an optimized use of the network.

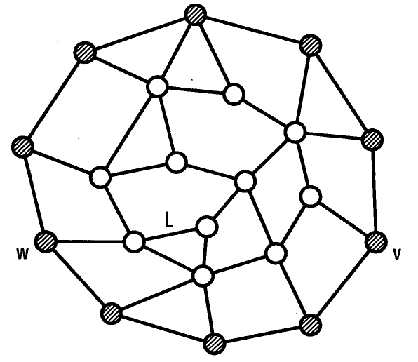

### CROSS REFERENCE TO RELATED APPLICATIONS

This application is the US National Stage of International Application No. PCT/EP2004/000218, filed Jan. 14, 2004 and claims the benefit thereof. The International Application claims the priority of German application No. 10301967.7, filed Jan. 20, 2003, both of which are incorporated by reference herein in their entirety.

### FIELD OF THE INVENTION

The invention relates to a method for traffic restriction in a packet-oriented network.

### SUMMARY OF THE INVENTION

Currently the development of technologies for packet-based networks is a central field of activity for engineers from the areas of network technology, call-processing technology and Internet technologies.

The primary aim of such developments is to enable a packet-oriented network to be used for any services where possible. Traditionally data has been transmitted over packet-oriented networks for which the timing of transmission is not a critical factor, for example the transfer of files or electronic mail. Speech transmission with real-time requirements is traditionally handled using telephone networks with the aid of time division multiplexing. Such networks are also frequently referred to as TDM (Time Division Multiplexing) networks. The laying of networks with high bandwidth or transmission capacity has brought the implementation of image-based services in addition to speech and data transmission into the realms of the possible. Transmission of video information in real time, e.g. within the framework of video-on-demand services or video conferences, will become an important category of services in future networks.

The aim of the development is to be able to execute all services, data-related, voice-related and services relating to video information, via one packet-oriented network. For the different requirements of data transmission within the context of the different services classes of service are usually defined. Transmission with a defined quality of service, particularly for services with real-time requirements, demands a corresponding controller or control for packet transmission over the network. There are a series of terms used in relation to checking or controlling the traffic: traffic, traffic conditioning, traffic shaping, traffic engineering, policing etc. Different procedures for checking or controlling the traffic of a packet-oriented network are described in the relevant literature.

With ATM (Asynchronous Transfer Mode) networks a reservation is made for each data transmission on the transmission link as a whole. The volume of traffic is restricted by the reservation. To monitor the transmission overload each section of the link is checked. Any discarding of packets is undertaken in accordance with the CLP bit (CLP: Cell Loss Priority) of the packet header.

The Diff-Serv (Differentiated Services) concept is employed with IP (Internet Protocol) networks and aims to provide a better quality of service for services with high quality requirements by introducing classes of service. A CoS (Class of Service) model is also frequently referred to in this context. The Diff-Serv concept is described in RFCs number 2474 and 2475 published by the IETF. Within the framework of the Diff-Serv concept, a DS (Differentiated Services) field in the IP header of the data packets is used to prioritize packet traffic by setting the DSCP (DS codepoint) parameter. This prioritization is undertaken using a “per hop” resource allocation, i.e. the packets are handled differently at the nodes depending on the class of service set in the DS field by the DSCP parameter. The checking or control of the traffic is also undertaken in accordance with the classes or service. The Diff-Serv concept leads to privileged handling of the traffic of prioritized classes of service, but not to reliable control of the volume of traffic.

Another approach to transmission in relation to a quality of service over IP networks is provided by the RSVP (resource reservation protocol). This protocol is a reservation protocol, with the aid of which bandwidth is reserved along a path. A quality of service (QoS) transmission can then be undertaken via this path. The RSVP protocol is used together with the MPLS (multi protocol label switching) protocol which makes virtual paths over IP networks possible. For a guarantee of QoS transmission the volume of traffic is checked as a rule along the path and restricted if necessary. By introducing paths however much of the original flexibility of IP networks is lost.

Central to guarantees of transmission quality parameters is efficient checking of the traffic. In checking the volume of traffic as part of data transmission over packet-oriented networks a high degree of flexibility and low complexity in the data transmission should also be a consideration, as is demonstrated to a high degree by IP networks for example. This flexibility or low level of complexity are however largely lost again when the RSVP protocol with end-to-end path reservation are used. Other methods such as Diff-Serv do not lead to any guaranteed classes of service.

The object of the invention is to specify efficient traffic control for a packet-oriented network which avoids the disadvantages of conventional methods.

The object is achieved by the claims.

Within the context of the inventive method an authorization check related to a link is conducted for a group of data packets of a flow to be transmitted over the network. In the first inventive method the authorization check is conducted by means of a limit value for the part of the traffic flowing over the link which has entered the network via the ingress node, via which the group of data packets is also to enter the network. The transmission of the group of data packets is not authorized if authorizing the transmission would lead to a volume of traffic which exceeds the limit value.

In the second inventive method the authorization check is conducted by means of a limit value for the part of the traffic flowing over the link which is transmitted onwards to the egress node via which the group of data packets is to leave the network. The transmission of the group of data packets is not authorized if authorizing the transmission would lead to a volume of traffic which exceeds the limit value.

In accordance with a further development, two authorization checks are conducted for the packets of the flow, one by means of the limit value for the traffic of the flow routed via the network ingress node which flows over the link, the other with the aid of the limit value for the traffic routed via the link which leaves the network via the same egress node as the flow.

Authorization checks can for example be conducted at the ingress node via which the flow is to be transmitted into the network.

A link can for example be produced by connecting two network nodes. The term link or connection link is generally used.

The packet-oriented network involved can also be a part network or a subnetwork. In IP (Internet Protocol) systems there are for example network architectures in which the overall network is subdivided into networks called “autonomous systems”. The network in accordance with the invention can for example be an autonomous system or the part of the overall network in the area of responsibility of a service provider (e.g. an ISP: Internet Service Provider). In the case of a part network, traffic control in the part networks and an efficient communication between the part networks can be used to define service parameters for a transmission over the entire network.

The term “flow” is usually used to designate the traffic between an origin and a destination. In this document flow relates to the ingress nodes and den egress nodes of the packet-oriented network, i.e. all packets of a flow in the sense in which we are referring to it are transmitted via the same ingress nodes and the same egress nodes. The group of packets is for example assigned to a connection (defined for a TCP/IP transmission by an IP address and port number of origin and destination process) and/or a class of service.

Ingress nodes of the packet-oriented network are nodes via which the packets are routed into the network; Egress nodes are node of the networks via which the packets leave the network. Literature frequently refers to entry point nodes as ingress nodes and exit point nodes as egress nodes. For example a network can be produced which comprises marginal nodes and internal nodes. If for example packets can enter the network or leave it via all marginal nodes of the network, the marginal nodes of the network would in this case be referred to as ingress nodes and also egress nodes.

An authorization test in accordance with the invention can be conducted by a control entity in a node or by computers connected upstream from the node. A control entity in this case can assume control functions for one or more nodes.

The authorization check in accordance with the invention controls the volume of traffic on a link of the network. A limit for the overall volume of traffic of the link can be determined by summation over all ingress nodes or egress nodes of the network of the limit values relating to the link. The traffic restriction enables overload situations or blockages on the link to be prevented. For example limit values are set with the aid of statistical information so that there is only a very small probability of an overload or blockage occurring. Delays and discarding of packets are thereby prevented.

A restriction or check on the volume of traffic in accordance with the invention can be conducted for all links of the network. For a flow to be transmitted an inventive access control is then undertaken for all links over which the packets of the flow are to be transmitted and the flow is not authorized if one of the access controls does not produce a positive result, i.e. the limit value is exceeded for a link in the path of a data packet of the flow.

The volume of traffic can be restricted in the sense of a transmission with negotiated quality-of-service features (SLA:service level agreements), e.g. in accordance with the prioritization of the traffic. For low-priority traffic for example the limit values can take account of a higher probability of packets being discarded.

For a guarantee for services with QoS data transmission it is important to control the entire volume of traffic within the network. This object can be achieved by fixing limit values for all ingress nodes and egress nodes for the traffic routed over the nodes. The limit values relating to links for the traffic routed via the ingress and egress nodes can be set to relate to values for the maximum volume of traffic of the relevant link by summing the limit values for all ingress nodes or egress nodes. The maximum value for the volume of traffic on links will in general not only be governed by the bandwidth here, but also by the network technology used. For example account will normally have to be taken of whether the network is a LAN (Local area Network), a MAN (Metropolitan Area network), a WAN (Wide Area network) or a backbone network. Parameters other than the transmission capacity, for example delays in transmission, must be taken into account for example for networks with real-time applications. For example a level of loading of almost 100 for LAN with CSMA/CD (Carrier Sense Multiple Access (with) Collision Detection) is associated with delays which as a rule excludes realtime applications. From the maximum values for the maximum volumes of traffic on links the limit values can then be defined for the traffic routed via the ingress and egress nodes.

The relationship between individual flows, able to be characterized for example by means of ingress and egress nodes, and the proportional volume of traffic over the individual links of the network can be determined on the basis of empirical values or known properties of nodes and links. It is also possible to dimension the network to obtain this proportionate volume of traffic over the individual links depending on the ingress nodes and egress nodes. In traffic theory the terms traffic matrix and traffic pattern are frequently used. The entries of the traffic matrix are given in this case by the average amount of traffic which is expected between the pairs of ingress nodes and egress nodes assigned to the matrix elements. The term traffic pattern differs from this in that it refers to the real traffic present. From the traffic matrix and information about routing within the network the limit values used in accordance with the invention can be determined so that overload situations are avoided.

The invention has the advantage that information for access control must only be kept at ingress and egress nodes. This information typically includes for an ingress node or egress node the limit values and current values for the traffic routed via the node concerned. The scope of the information is restricted. It takes little effort to update the information. The internal nodes do not need to take over any functions with regard to access control. The method is thus considerably less effort and has a lower degree of complexity than methods which provide authorization checks for the links. By contrast with conventional methods such as ATM or MPLS, no path needs to be reserved within the network.

Inventive access controls can be combined with further access controls, with the packets of the flow being allowed if all access controls yield a positive result. Other possible access controls use the following limit values for example:
Limit value for the overall traffic which flows into the network via the ingress node.
limit value for the overall traffic which flows out of the network via the egress node.
Limit value for the overall traffic between an ingress node and egress node pair.

These further access controls can all be performed at the margins of the network so that the internal nodes of the network do not have to store any status information relating to links for access control.

A relationship can be established between the overall volume of traffic on the individual links of the networks and the limits values used for authorization checks. The relationship can be established as an optimization problem with peripheral conditions or ancillary conditions in the form of inequalities. In this case the proportionate volume of traffic over the individual links of the network is included for formulating the relationship between the volume of traffic between pairs of ingress nodes and egress nodes and the volume of traffic on a link of the network.

This formulation allows additional further criteria in the form of inequalities to be included in the determination of the limits or limit values. Conditions in the form of inequalities can be included for example in the determination of limits or limit values for the authorization checks which dictate a low volume of high-priority traffic on links with longer delay times. Another example is that of an egress node via which packets can be transmitted to a number of ingress nodes of other networks, i.e. the egress node has interfaces to a number of other networks. If ingress nodes of one of the subsequent networks can process a lower volume of data than the egress node, it can be ensured through a further ancillary condition in the form of an inequality that the traffic routed via the egress node to the ingress node exceeds its capacity.

In accordance with a further development of the invention, on failure of a link, new limits or limit values for the authorization checking or the authorization checks are established with the condition that no packets are transmitted over the failed link. Setting the new limits means that the traffic which would otherwise have been transmitted over the failed link is transmitted over other links without this leading to an overload as a result of the diverted traffic. This allows a flexible reaction to failures.

Preventive protection against link outages can be guaranteed by selecting the limit values or the limits. In this case it is possible to determine, for a plurality of possible malfunctions, limits or limit values for which in each case the volume of traffic remains within a permitted framework even in the event of a malfunction, i.e. parameters such as propagation delay and packet loss rate remain within ranges defined by the quality requirements for the data transmission. The limits or limit values are then set to the minimum of the values for the malfunctions investigated. I.e. each of the malfunctions is picked up by the choice of limits or limit values. The plurality of malfunctions can for example include all failures of links.

The invention will be explained below in more detail on the basis of a FIGURE within the framework of an exemplary embodiment.

### BRIEF DESCRIPTION OF THE DRAWING

The sole FIGURE shows a network in accordance with the invention.

### DETAILED DESCRIPTION OF THE INVENTION

The FIGURE shows a network in accordance with the invention. Marginal nodes are indicated by solid circles, internal nodes by non-solid circles. Links are illustrated by connectors between nodes. In the example an ingress node is indicated by the letter w, an egress node by the letter v and a link by L. A part of the traffic between the nodes I and E is transmitted via the link L. Authorization checks at the ingress node w and at the egress node v together with authorization checks at other marginal nodes ensure that no overload arises on the link L.

Mathematical relationships are shown below for the inventive method. In practice limits or limit values are generally fixed depending on the maximum link capacities. To make the mathematical representation simpler the reverse case is considered below, i.e. the dimensioning of the links is calculated as a function of the limits or limit values. The reverse problem can then be resolved with numeric methods.

For the more detailed presentation below the following variables are introduced:
ILB(L,w): The limit value for the traffic over the link L which enters into the network at the ingress node w (ILB stands for Ingress Link Budget),
ELB(L,v): The limit value for the traffic over the link L which exits from the network at the egress node v (ELB stands for Egress Link Budget),
c(L,F): the aggregated traffic volume on the link L,
aV(w,v,L): the proportion of traffic volume over the link L of the overall traffic volume between the ingress node w and the egress node v,
Ingress(w): The limit value for the traffic over the ingress node w,
Egress(v): The limit value for the traffic over the egress node v,
δ(w,v): the volume of traffic between the ingress node w and the egress node v.
BBB(w,v): the limit for the volume of traffic between the ingress node w and the egress node v,

The volume of traffic c(L, F) on the link L is made up of the aggregated proportional contributions of the individual flows routed over the link L. Let f1, . . . , fn be the flows, of which a part of the traffic is routed over the link L and let p(L,fi), I ε {1, . . . ,n}, be measurements for the proportion of the flow fi routed over the link L. The following then applies: c(L, F)=Σ fi * p (L, fi), sums of I=1, . . . , n.

A flow from the ingress node w to the egress node v is not allowed if, on authorization of the flows on a link L, the proportion of c(L,F) which has entered the network via the ingress node w would exceed the limit value ILB(L,w) or the proportion of c(L,F) which flows to the egress node v would exceed the limit value ELB(L,v).

In the dimensioning of the network the following two conditions are to be adhered to for all links L:
c(L,F)≦Σ ILB(L,w), sum of all ingress nodes w (1)
and
c(L,F)≦Σ ELB(L,v), sum of all egress nodes v. (2)
For all links L the following applies:
c(L,F) Σ δ(I,j)·aV(w,v,L), sum of all w and v. (3)
e.g. with the aid of the simplex algorithm, for predetermined values of ILB(L,w) and ELB(L,v) the maximum c(L,F) can be computed which fulfills the inequalities (1), (2), or (1) and (2). (Solution of the equation (3) with peripheral conditions (1), (2), or (1) and (2)). Conversely for a set of limits or limit values ILB(L,w) or ELB(L,v) a check can be made as to whether an impermissibly high load can occur on a link L. In this case a modification of the limits or limit values to counter the situation can be undertaken.

The inventive method allows faults to be reacted to in simple way by modifying the limits or limit values. Thus, if a link L fails, the relationship of this link can be excluded (e.g. by zeroing all aV(I,j,L) for this link L). By reformulating the context modified limits or limit values can be determined which as authorization criteria prevent overload within the network.

For embodiment with an additional authorization check
either by means of a limit value Ingress(w) for the traffic flowing into the network at an ingress node,
or by means of a limit value Egress(v) for the traffic leaving the network at an egress node,
or by means of a limit value BBB(w,v) for the volume of traffic between ingress node w and egress node v
   further inequalities can be formulated:

For all ingress nodes w
Σ δ(w,v)≦Ingress(w), sum of all v. (4)
For all egress nodes v
Σ δ(w,v)≦Egress(v), sum of all w. (5)
For all pairs (w,v)
δ (I,j)≦BBB(w,v). (6)

Solving equation (3) again under peripheral conditions applies. The optimization can be undertaken under any given combination of conditions (1), (2), (4), (5) and (6). A set of conditions of the form (1), (2), (4), (5) or (6) for all links L, all ingress nodes w or egress nodes v in each case or all pairsl (w,v) of ingress and egress nodes are sufficient for dimensioning the network. Further conditions can be added as required as complex sets of conditions (i.e. for all links L or all ingress nodes w for example) or as individual conditions (e.g. conditions (1) or (2) for a specific link L). Since with additional conditions in the formulation of the problem more conditions are to be fulfilled, the maximum values for c(L,F) are less than or equal to those for the solution without additional conditions Additional conditions restrict the solution space and lead with the same values for the limit values to smaller values c(L,F) as regards the dimensioning of the links L. With the reversal of the problem the result is that with the same predetermined values for the maximum capacity c(L,F) of the links L additional conditions lead to larger values for the limit values. This provides more flexibility for fixing the limits, and thus as regards the optimum loading of the network. Additional conditions can for example be introduced in accordance with the topology of the network.

The invention is also related to a marginal node comprising means for executing a method for restricting traffic in a packet-oriented network with a plurality of links, in which
for a group of data packets of a flow to be transmitted over the network an authorization check relating to a link (L) is conducted, in which case
the group of data packets is to enter into the network at an ingress node (w),
the authorization check is conducted by means of a limit value (ILB(L,w)) for the entire traffic which enters at the ingress node (w) and is routed via the link (L), and
the transmission of the group of data packets is not authorized if the authorization of the transmission would lead to traffic on the link (L) exceeding the limit value (ILB(L,w)).

1-8. (canceled)

9. A method for restricting traffic in a packet-oriented network having a plurality of links, the method comprising:
performing an authorization check relating to each link via which a group of data packets of a flow is transmitted over the network, wherein
the group of data packets enters into the network at an ingress node, wherein
the authorization check is performed by means of a limit value for the entire traffic which enters at the ingress node and is routed via the link.

10. The method in accordance with claim 9, wherein the transmission of the group of data packets is not authorized if the authorization of the transmission would lead to traffic on the link exceeding the limit value.

11. The method in accordance with claim 9, wherein
two authorization checks relating to the link are performed, wherein
a first authorization check corresponding to claim 9 is performed, wherein
a second authorization check is performed in which
an authorization check relating to the link is performed for the group of data packets, wherein
the group of data packets leaves the network at an egress node, wherein
the second authorization check is performed by means of a further limit value for the entire traffic which leaves the network via the egress node and is routed via the link, and wherein
the transmission of the group of data packets is not authorized if an authorization of the transmission would lead to traffic on the link exceeding either the limit value or the further limit value.

12. The method in accordance with claim 9, further comprising:
performing a further authorization check, wherein
the further authorization check is performed by means of a limit value for the entire traffic of the flow routed via the ingress node, and wherein
the transmission of the group of data packets is not authorized if authorizing the transmission would lead to traffic at the ingress node which would exceed the limit value.

13. The method in accordance with claim 9, further comprising:
performing a further authorization check, wherein
the further authorization check is performed by means of a limit value for the entire traffic of the flow routed via the egress node, and wherein
the transmission of the group of data packets is not authorized if the authorization of the transmission would lead to traffic exceeding the limit value at the egress node.

14. The method in accordance with claim 9, further comprising:
performing a further authorization check, wherein
the further authorization check is performed by means of a limit value for traffic routed from the ingress node of the flow to the egress node, and wherein
the transmission of the group of data packets is not authorized if authorization of the transmission would lead to traffic exceeding the limit value between the ingress node and the egress node.

15. A method for restricting traffic in a packet-oriented network having a plurality of links, the method comprising:
performing an authorization check relating to a link for a group of data packets of a flow to be transmitted over the network, wherein
the group of data packets leaves the network at an egress node, wherein
the authorization check is performed by means of a limit value for the entire traffic which leaves the network via the egress node and is routed via the link.

16. The method in accordance with claim 15, wherein the transmission of the group of data packets is not authorized if the authorization of the transmission would lead to traffic exceeding the limit value on the link.

17. The method in accordance with claim 15, wherein
two authorization checks relating to the link are performed, wherein
a first authorization check corresponding to claim 15 is performed, wherein
a second authorization check is performed in which for the group of data packets of the flow to be transmitted over the network an authorization check relating to the link is performed, wherein
the group of data packets enters the network at an ingress node,
the authorization check is performed by means of a further limit value for the entire traffic which enters at the ingress node and is routed via the link, and wherein
the transmission of the group of data packets is not authorized if an authorization of the transmission would lead to traffic on the link exceeding either the limit value or the further limit value.

18. The method in accordance with claim 15, wherein the method is performed for all links.

19. The method in accordance with claim 17, wherein the method is performed for all links.

20. The method in accordance with claim 15, further comprising:
performing a further authorization check, wherein
the further authorization check is performed by means of a limit value for the entire traffic of the flow routed via the ingress node, and wherein
the transmission of the group of data packets is not authorized if authorizing the transmission would lead to traffic at the ingress node which would exceed the limit value.

21. The method in accordance with claim 15, further comprising:
performing a further authorization check, wherein
the further authorization check is performed by means of a limit value for the entire traffic of the flow routed via the egress node, and wherein
the transmission of the group of data packets is not authorized if the authorization of the transmission would lead to traffic exceeding the limit value at the egress node.

22. The method in accordance with claim 15, further comprising:
performing a further authorization check, wherein
the further authorization check is performed by means of a limit value for traffic routed from the ingress node of the flow to the egress node, and wherein
the transmission of the group of data packets is not authorized if authorization of the transmission would lead to traffic exceeding the limit value between the ingress node and the egress node.

23. A marginal node comprising means for executing a method in accordance with claim 15.
